(19) United States
(12) Patent Application Publication
(10) Pub. No.: US 2013/0139706 A1
(43) Pub. Date: Jun. 6, 2013

(54) MOBILE SMOKER OVEN

(71) Applicant: Michael Robertson, Alamo, TN (US)

(72) Inventor: Michael Robertson, Alamo, TN (US)

(21) Appl. No.: 13/805,415

(22) PCT Filed: Jun. 30, 2011
(86) PCT No.: PCT/US2011/042602

§ 371 Date: Jan. 30, 2013

Related U.S. Application Data
(60) Provisional application No. 61/362,359, filed on Jul. 8, 2010.

(51) Int. Cl. A47J 37/04

(52) U.S. Cl. CPC A47J 37/04
USPC 99/419

(57) ABSTRACT

A trailer mounted oven (20) wherein the oven (22) includes a food preparation or cooking chamber (58) equipped with a rotisserie (64) capable of mounting a plurality of removable racks (86) or spits (82) for holding meat or other foods and a gas fired firebox (47) separated from the cooking chamber (58) by a baffle (60). A circulating fan (103) with a downwardly angled fan shaft is positioned to circulate heat and smoke through the cooking chamber (58). A separate control apparatus compartment (98) includes electronics, fan motor (102) and a rotisserie drive motor (108). A second fan (104) in the control apparatus compartment (98) provides cooling air to the motors and the control electronics. The oven includes a controller (116) that operates the gas burner (134). The oven is constructed from stainless steel bolted together using a uniform bolt pattern, which allows the removable attachment of a plurality of accessories.

### CROSS-REFERENCE TO RELATED APPLICATIONS

This application claims the benefit of provisional application Ser. No. 61/362,359, filed Jul. 8, 2010, which is incorporated herein by reference.

### STATEMENT REGARDING FEDERALLY SPONSORED RESEARCH OR DEVELOPMENT

Not applicable.

### BACKGROUND OF THE INVENTION

The invention relates generally to ovens for preparing food products, and more particularly to a mobile barbeque oven or smoker.

Food products, for example meats such as beef, pork, and poultry, as well as fish and the like, traditionally are prepared for consumption by subjecting the raw product to sufficient heat so as to cook the product to an appropriate level of doneness. Various ovens or cookers are used for roasting, broiling, smoking or barbequing meat. In many instances, the cookers or ovens used to prepare the product have a cooking chamber and a source of convection heat, for example, electric heating elements, gas jets, wood or charcoal burners. In commercial food preparation, for example in restaurants, large ovens are employed to cook or prepare large quantities of product at one time. For example, large convection ovens or barbeque ovens or smokers are used to prepare batches of food products, such as roasts, ribs, chickens, fish and sometimes potatoes and other vegetables. These products generally are placed on racks inside the cooking chamber and subjected to heat and/ or smoke. These commercial ovens, particularly barbeque ovens or smokers, usually impart a unique and desired flavor and quality to the prepared foods.

These commercial ovens or smokers function well for their intended purposes. However, the commercial ovens or smokers generally are fixtures in a restaurant or other food preparation facility. They are large, heavy and often connected to a source of fuel, such as natural gas and electricity. There are myriad opportunities to provide cooked or smoked food products, such as barbeque, at sites remote from a commercial oven or smoker. For example, small barbeque stand operators, caterers and barbeque competition participants prepare smaller quantities of food products outside the conventional restaurant or food preparation setting. Small barbeque pits or smokers are known. However, the typical small barbeque pits or smokers do not have the same cooking features and do not produce product having the desired characteristics of commercial barbeque ovens or smokers. Many individuals desire to prepare food products in a manner similar to those prepared in the large commercial barbeque ovens or smokers.

It would be advantageous, therefore, to provide a smaller barbeque oven or smoker for preparation of food products that includes many of the same cooking features as a larger commercial oven or smoker.

Also, it would be advantageous to provide such an oven that is mobile and that can be transported to any desired site for food preparation.

It would be advantageous to provide such an oven that a number of accessories and features that allow customization of the oven as desired by the user.

### SUMMARY OF THE INVENTION

In one aspect of the invention, a trailer mounted oven is provided wherein the oven includes a food preparation or cooking chamber equipped with a rotisserie capable of mounting a plurality of removable racks or skewers for holding meat or other foods. There is a heat source, generally in the form of a gas fired firebox for burning wood or charcoal separated from the cooking chamber by a baffle. There is a circulating fan, operatively connected to a fan motor, positioned adjacent the baffle and above the rotisserie, the fan is optimally angled to circulate heat and smoke through the cooking chamber.

The oven includes a separate insulated compartment adjacent the cooking chamber that houses the oven control apparatus including appropriate operational electronics, the fan motor and a rotisserie drive motor. The oven includes a controller that operates the gas burner in response to thermostat settings and the operation of the rotisserie.

The rotisserie drive motor shaft includes a small sprocket that is operatively connected to a second, larger sprocket attached to one end of the rotisserie axle. In general the two sprockets are connected by a chain drive. The gear ratio between the two sprockets is such that the rotisserie turns at approximately four (4) revolutions per minute.

In one aspect, the opposite end of the rotisserie axle extends out of the wall of the oven to function as a power takeoff for mounting a food grinder or shredder.

A second fan, located in the insulated compartment and operatively connected to the fan motor, provides air circulation to keep the motors and the control electronics cool while the oven is in operation.

The oven is constructed from high grade stainless steel. Various components are bolted together using a uniform bolt pattern. The uniform bolt pattern allows the removable attachment of a plurality of accessories, such as shelves, work surfaces, sinks, receptacles, ancillary grills and the like to the outside walls of the oven.

The trailer comprises a trailer frame, wheels, tongue with trailer hitch and proper wiring for operation. The trailer can include a forward section for mounting propane gas tanks, a generator, an ice chest or other desired or useful devices.

### BRIEF DESCRIPTION OF THE DRAWINGS

FIG. 1 is a front left perspective view of a representative embodiment of the mobile oven of the present invention;

FIG. 2 is a right side elevational view thereof;

FIG. 3 is a left rear perspective view of the mobile oven with the doors in an open position;

FIG. 4 is a rear elevational view of the mobile oven with the doors in a closed position;

FIG. 5 is an elevational view of the cooking chamber showing the rotisserie with whole chicken skewers;

FIG. 6 is an elevational view of the cooking chamber showing the rotisserie with single level racks;

FIG. 7 an elevational view of the cooking chamber showing the rotisserie with dual level racks;

FIG. 8 is a perspective view of an inside wall of the cooking chamber showing one end of the rotisserie;

FIG. 9 is a perspective view of the inside of the cooking chamber showing the opposite end of the rotisserie and the circulating fan;

FIG. 10 is a perspective view of the compartment housing the operational electronics, the fan motor and the rotisserie drive motor;

FIG. 11 is a partial left side perspective view of the mobile oven with the protective cover removed showing the rotisserie drive sprocket;

FIG. 12 is a perspective view of the top of the inside of the firebox;

FIG. 13 is an elevational view of the firebox;

FIG. 14 is a partial enlarged perspective view of the firebox ash receptacle with a handle attached; and

FIG. 15 is a perspective view of the foot operated rotisserie advance switch.

### DETAILED DESCRIPTION

The following is a detailed description of preferred aspects of the present invention including the best mode of carrying out the invention presently known to the inventor.

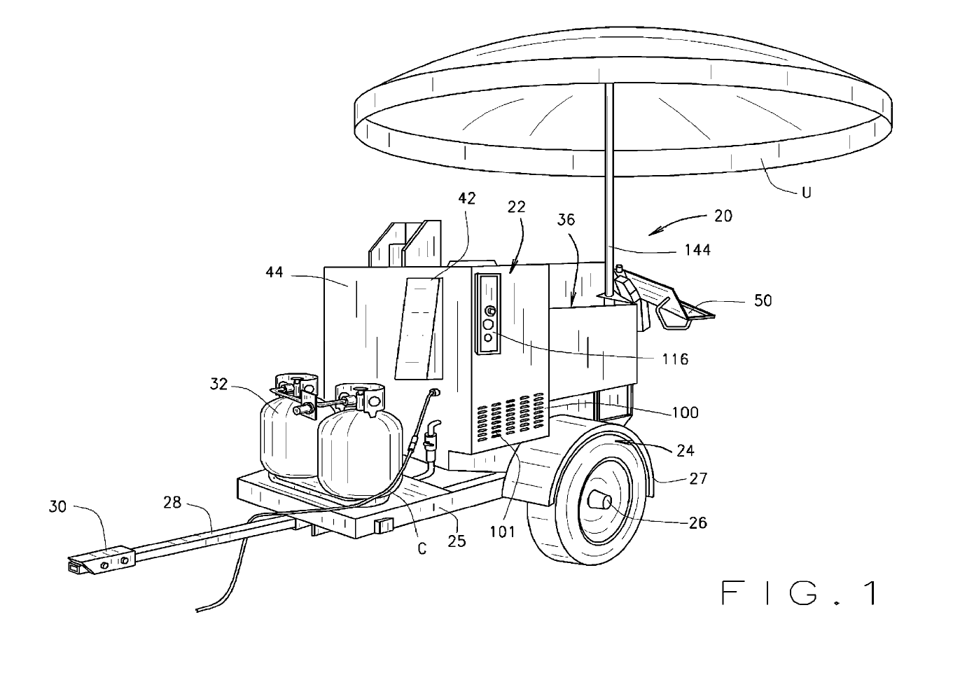

One aspect of the invention is a mobile food preparation apparatus, which may be referred to as an oven or a smoker, a barbeque, a rotisserie or any one of a number of common or colloquial names for devices designed to prepare or cook meats and other food items. The mobile oven of the present invention is indicated generally be reference numeral 20 in FIGS. 1 through 3. Mobile oven 20 comprises two main apparatus, an oven 22 and a trailer 24. Although oven 22 is illustrated as mounted on trailer 24, it will be understood that oven 22 can be transported on trailer 24 and offloaded. It can be equipped with legs or legs with casters or any appropriate support structures.

It will be noted that oven 22 can function appropriately when mounted on trailer 24. The term trailer is used for simplicity, however, the term is intended to include any wheeled apparatus used to impart mobility to the oven, including a carriage or axles and wheels functionally associated directly with, or part of, the oven itself. As illustrated, trailer 24 can be of any appropriate design or configuration having a frame 25 with wheels 26. Trailer 24, as shown includes fenders 27, an elongated tongue 28 with a trailer hitch 30 of conventional design on the end of the tongue for attachment to a tow vehicle. In use the trailer can be unhitched and a depending wheel under the tongue lowered to support the trailer or the trailer can remained hitched to the tow vehicle during use of the oven. As illustrated, there are two propane tanks 32 secured on the forward end of the frame to provide fuel for the gas burner as will be explained. However, the forward end of the trailer can be configured to include other useful structures, such as an appropriately vented shroud over the propane tanks, an ice chest, a propane or electric powered refrigerated unit, a potable water storage tank or any other useful structures or elements.

Oven 22 is designed to prepare food products, generally by cooking with heat or flavored smoke or combinations thereof. A source of steam, such as a fluid reservoir, or a source of flavored smoke in the cooking chamber may be employed as well. The terms “food products” or “food product” is intended to include commonly prepared meats including, but not limited to, beef, pork, poultry, lamb, wild game, as well as fish or other seafood. The terms “food products” or “food product” also can include vegetables, such as ears of corn, potatoes, onions or any other product that may be prepared by one of heat, steam, flavored smoke, or any combination thereof. In other words, the terms “food products” and “food product” is intended to encompass any items prepared in the oven.

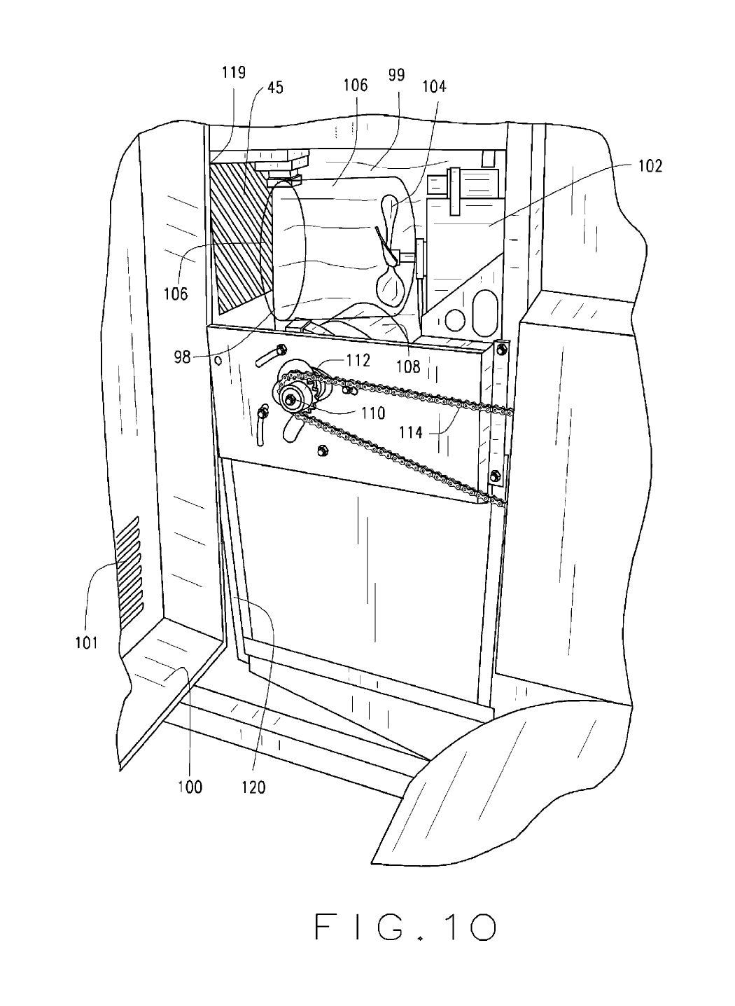

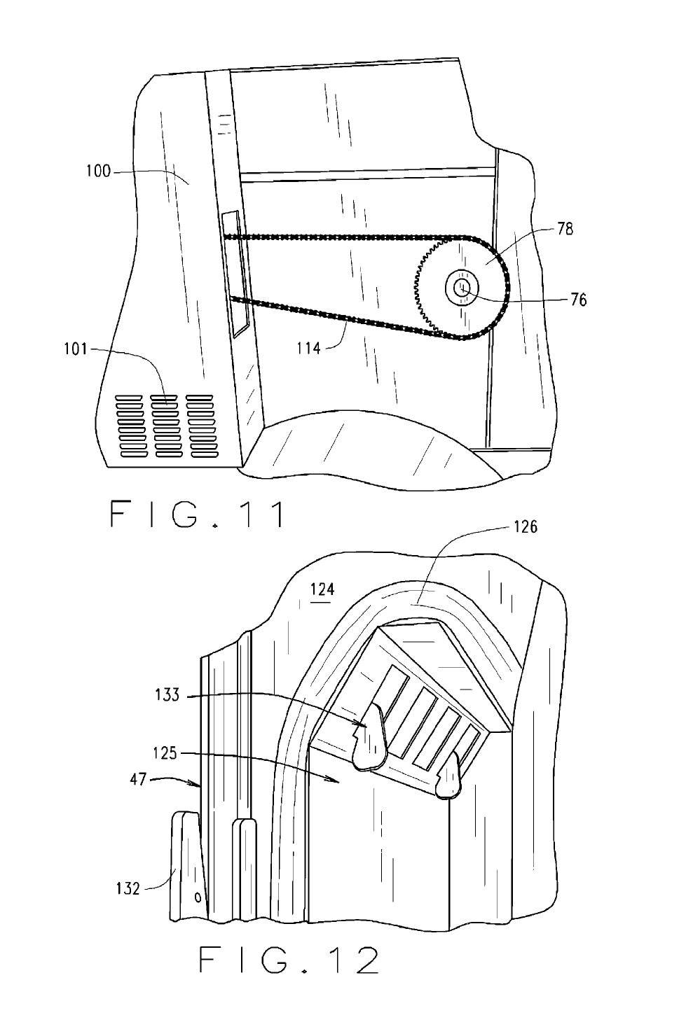

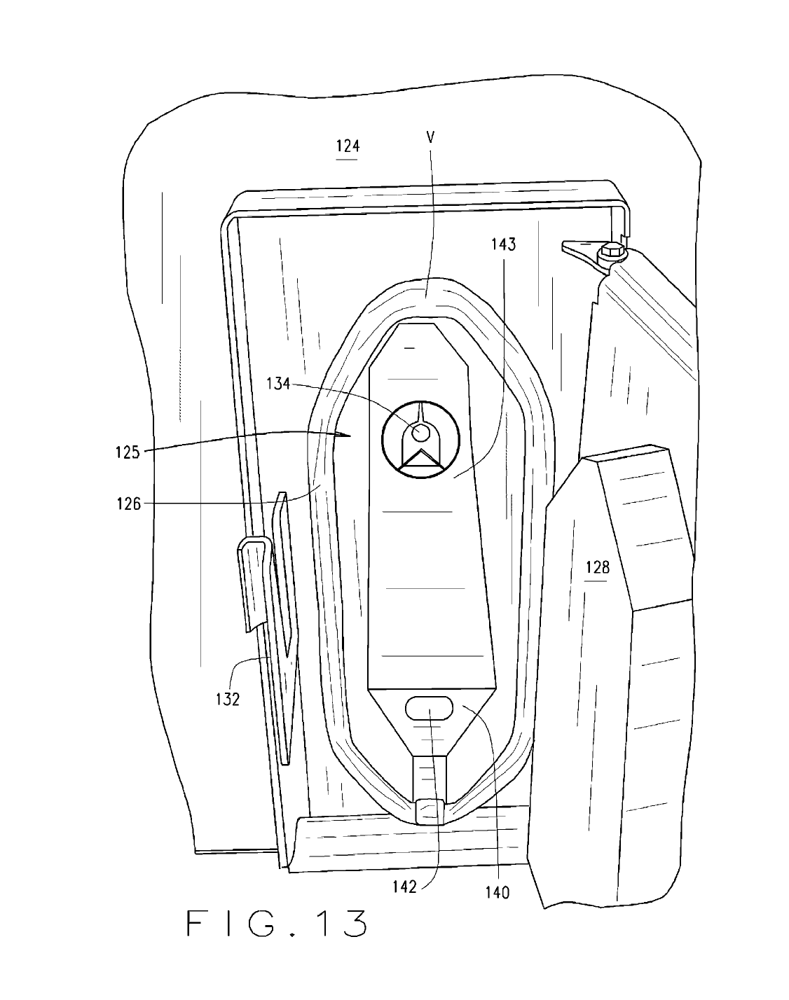

As shown, oven 22 includes a cabinet 34 having a first side wall 36, an opposite side wall 38, a back wall 40, a top wall 42 and a bottom wall (not seen). The bottom wall includes a waste product drain hole (not seen). The cabinet includes a front wall 44 with a vent 45 (FIG. 10) with a downwardly opening cover 46, which provides ventilation into the compartment that houses the operational apparatus such as the electronics and motors, as will be explained. The orientation of cover 46 keeps rain or moisture out of the operational electronics and motors. A firebox 47 is located behind front wall 44. The frame of firebox 47 protrudes slightly out of wall 38 includes a hinged door 48. Firebox 47 will be described in greater detail hereinafter. In a preferred aspect, the respective walls of oven 22 are constructed from a high quality stainless steel. Several of the wall components are welded together while most are joined with fasteners, for example, short bolts or screw and nut assemblies 49. The bolt pattern employed around the oven is uniform. The use of screw and nut assemblies 49, which are removable, in a uniform pattern allows for the attachment of various accessories, as will be explained below.

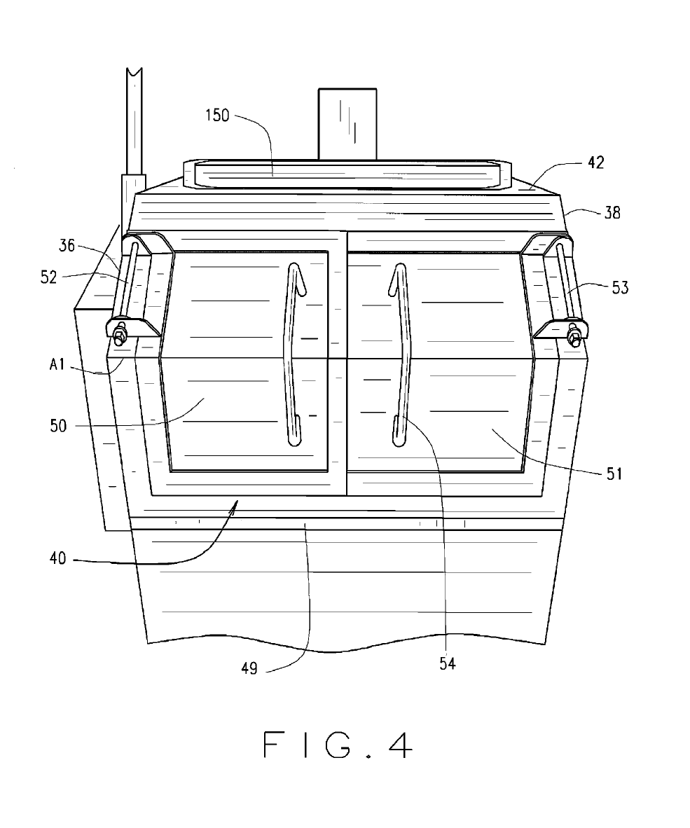

As best seen in FIG. 4, lower back wall 40 extends up vertically and then angles toward top wall 42 at an obtuse angle A1. Back wall 40 comprises a pair of opposed gull wing doors 50, 51 attached to the back wall by a pair of hinges 52, 53, respectively. Each door, which has a configuration complementary to the angled configuration of back wall 40, includes a handle 54. Doors 50 and 51, when opened, expose an opening 56 that allows access into a cooking chamber that will be described below. The configuration of the back wall provides for opening 56 to be angled as well. This angled configuration allows optimum access to the cooking chamber despite the relatively small size of oven 22 and opening 56. Doors 50 and 51 are configured to nest tightly in opening 56 to form a seal when the doors are closed. There can be a seal around opening 56, such as a fire resistant cord seal, or around the inside margins of the doors, or both, to better provide for sealed closure of the oven.

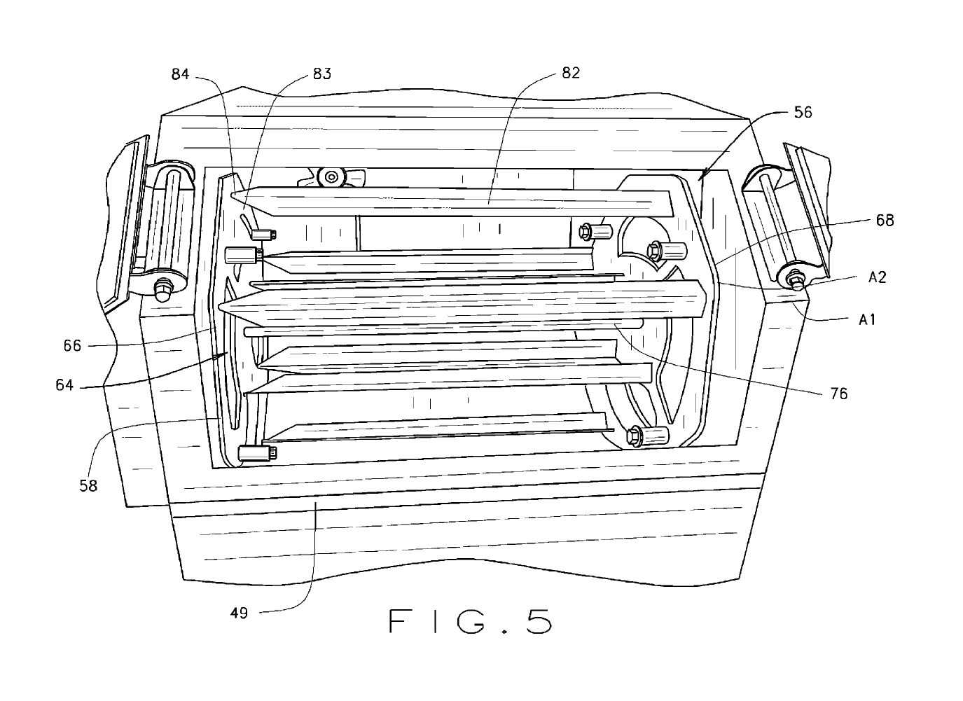

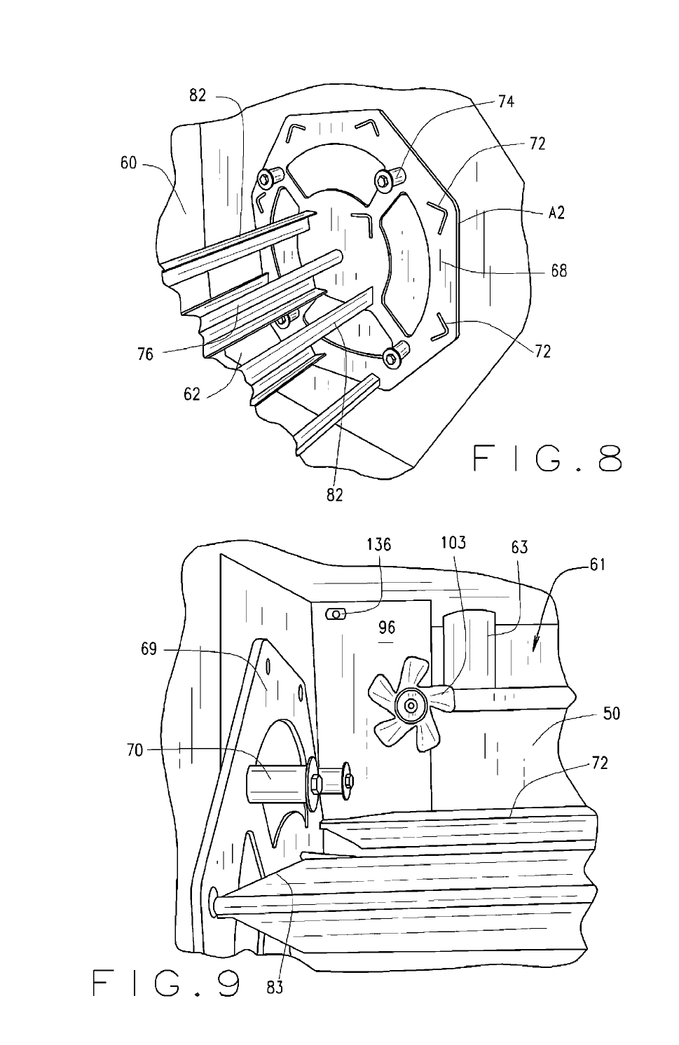

Referring to FIGS. 5 through 9, the respective walls define an internal food preparation or cooking chamber 58. Cooking chamber 58 can be insulated if the defining walls are insulated, but it is not critical to the operation of the invention. There is a baffle 60 at the front of the cooking chamber that separates cooking chamber 58 from the firebox, which will be explained. As illustrated baffle 60 comprises a laterally extending wall with a vertical height that is less than the vertical height of the cooking chamber so that baffle 60 can be positioned within the cooking chamber with air flow spaces 61 above and 62 below the baffle. There is a flue 63 that extends from approximately the top of baffle 60, through top wall 42. Flue 63 allows grease laden vapors, heat and smoke to escape so the cooking chamber does not build up pressure. Flue 63 is constructed so that it does not allow too much heat and air to escape and to help maintain temperature within the cooking chamber. Flue 63 can be constructed with a damper to control the egress of heat and smoke from the cooking chamber.

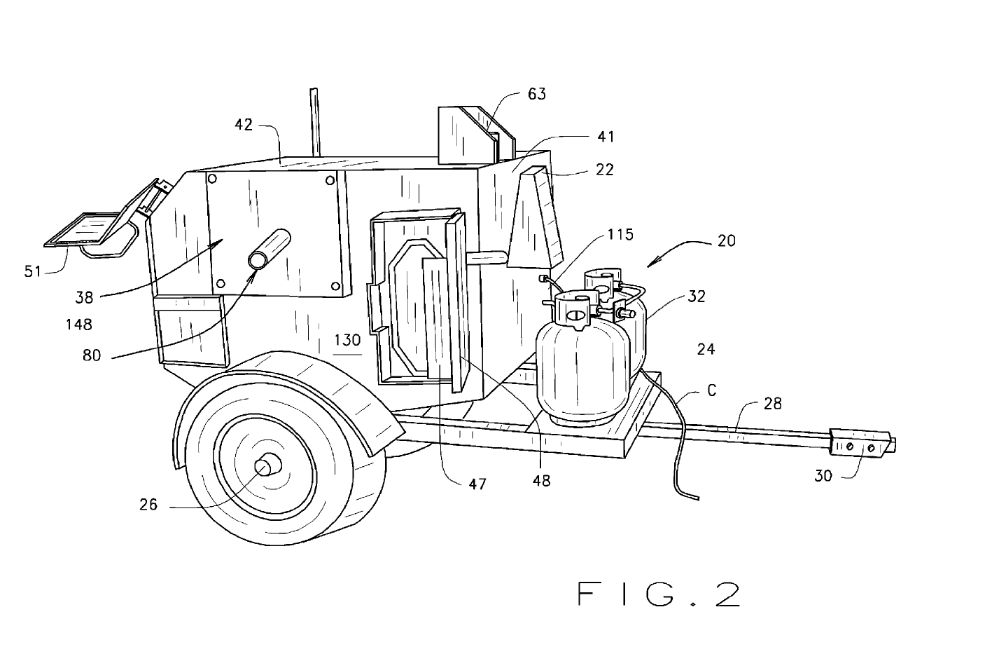

A rotisserie 64 is rotatably mounted between the two side walls. Rotisserie 64 includes a first end plate 66 and a second end plate 68. The end plates are substantially octagonal in shape having angles A2 that are substantially similar to the angle of rear wall. This complementary angle configuration provides easier access to the rotisserie through opening 56. First end plate 66 has a plurality of circular spit mounting holes 69 evenly spaced around the circumference of the plate. It also includes a plurality of evenly spaced cylindrical mounts or pins 70 that extend inwardly. Second end plate 68 includes a plurality of generally V-shaped spit mounting slots 72 evenly spaced around the circumference of the plate with one V-shaped slot 72 aligned with one hole 69. Second plate 68 also includes a plurality of evenly spaced cylindrical pins 74 extending inwardly, one each of the pins 74 corresponding to one pin 70 on the first plate. There is an axle 76 that extends between the two plates. A first end of axle 76 extends through side wall 36 and is operatively attached to an external sprocket 78, as see in FIG. 11. As seen in FIG. 11, sprocket 78 is covered by a panel 79. The second end of axle 76 can be mounted in a bushing (not seen). In an alternative embodiment, the second end of axle 76 can extend through wall 38 and terminate as an external power takeoff 80, as shown in FIG. 2.

Rotisserie spits 82 extend between the first and second end plates of the rotisserie. Spits 82 are unique in that they have substantially V-shaped cross section. A first end of the spit has a taper 83 that terminates in a short, substantially cylindrical tip 84 that engages a hole 69 in the first plate. The opposite end of the spit is a V-shaped end 85 that engages a V-shaped slot 72 in second end plate 68. As shown, the rotisserie of the present invention provides for twelve (12) spits, with eight (8) spits in an outer circle of spits and four (4) in an inner circle of spits.

The V-shaped spits are particularly adapted for the cooking of whole chickens. The spit can be inserted through the chicken. Tip 84 and taper 83 facilitate insertion of the spit through the chicken body. Several chickens can be mounted on a single spit, if desired. It will be understood that the V-shaped cross-section of the spit keeps the chicken the spit from rotating or spinning on the spit as the rotisserie rotates within the cooking chamber during cooking, which could result in the chicken having the same orientation throughout the cooking cycle. The orientation of entire chicken rotates as the rotisserie rotates and at a desired speed that will be discussed below. This optimum rotation of the chicken with the rotisserie while not freewheeling on the spit during cooking results entire surface of the chicken being optimally exposed to heat and smoked and allows juices that seep from the chicken to baste the chicken as it rotates through the cooking cycle. This self-basting aspect of the oven provides for a more evenly cooked and juicy chicken product. Moreover, the novel design allows chickens to be loaded on twelve (12) spits while avoiding touching, which may interfere with thorough, even cooking.

It will be understood that although the figures show the novel V-shaped spits, other configurations of spits can be employed, for example, more conventional two point or forked spits also could be used.

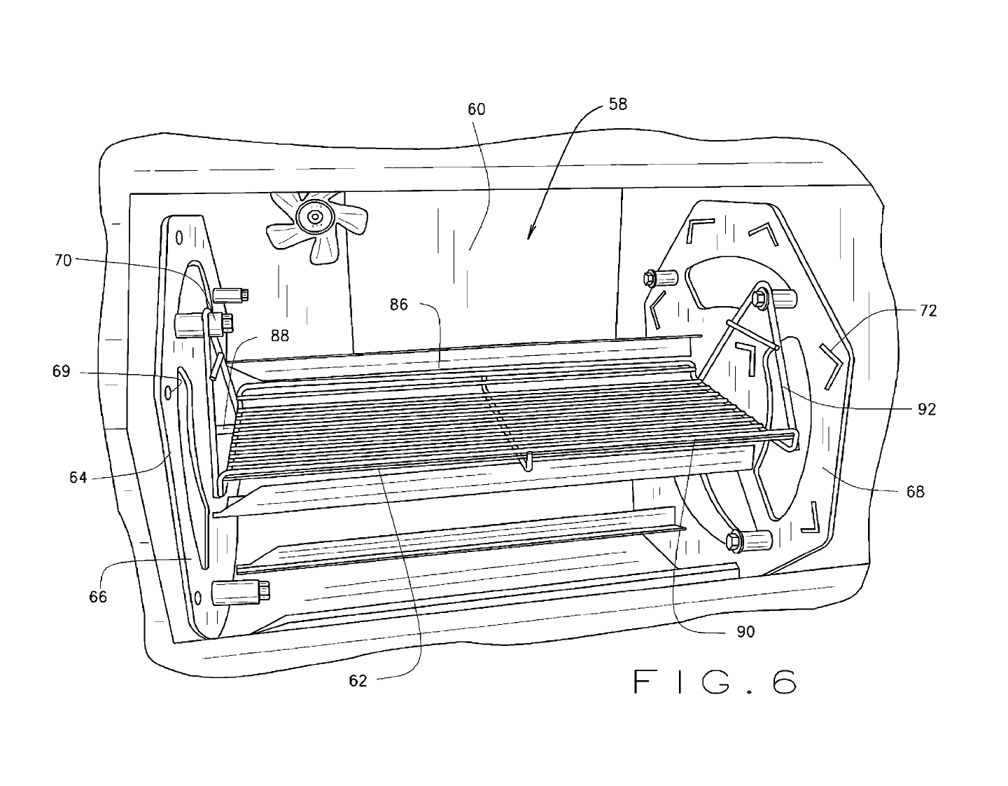

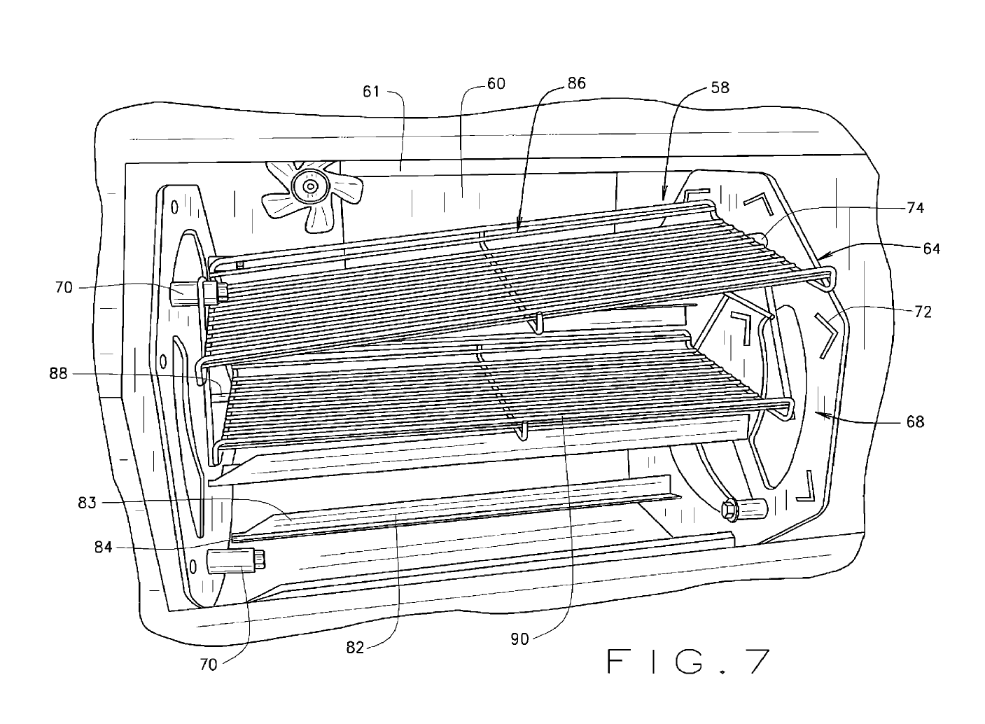

Referring to FIGS. 6 and 7, rotisserie 64 can include wire baskets or racks 86. Racks 86 have a planar surface 88 with upwardly and outwardly angled edges 90. There is a substantially triangular bail 92 at each end. The bails are designed so that the apex of the triangular bail hangs on cylindrical pins 72, 74. That is, the racks are pivotally mounted on the pins. It will be understood that as the rotisserie rotates, the pins will rotate within the apex of the bail and planar surfaces 88 of the racks loaded with food product will remain horizontal. Hence the design allows for a uniform orientation of the racks as the rotisserie turns. Also, it should be noted that because planar surface 88 is constructed from wire having gaps in between, juices from the meat on a given rack can flow through the rack and moisten or baste meat carried by a rack positioned below. As seen in FIG. 7, rack 86 can include a second or upper planar surface 94 that substantially increases the amount of food product that can be loaded on any given rack. In any event, in a preferred, mobile size oven 22 can accommodate up to 200 pounds of food product, for example, two hundred pounds of pork butts.

Referring to FIGS. 9 and 10, there is an inner wall 96 that defines an insulated compartment 98. Compartment 98 has insulation 99 against the heat of the cooking chamber and firebox. The outside of the compartment is covered by a removable panel 100. Panel 100 includes louvers 101 for ventilation. Compartment 98 houses the operational electronics and motors for operation of oven 22. For example, there is an electric fan motor 102 positioned in the upper part of the compartment. Fan motor 102 drives a first fan 103 which is located on wall 96 within the cooking chamber. Fan 103 has a downwardly angled fan shaft to optimize circulation of hot air and smoke within the cooking chamber. Fan motor also drives fan 104 which is positioned in compartment 98. The rotation of fan 104 draws outside air through vent 45 into compartment 98 for cooling. In another aspect of the invention, a cowling, as at 106, directs air from vent 45 toward fan 104.

Compartment 98 houses a second or rotisserie drive motor 108. Motor 108 includes a shaft 110 connected to a small sprocket 112. Referring to FIGS. 10 and 11 it will be seen that a drive chain 114 operatively connects sprocket 112 and sprocket 78. It is readily apparent that sprocket 78 is substantially greater in diameter than sprocket 112. The inventor has determined the optimum gear ratio between the large and small sprockets to be 6 to 1 (6:1). This gear ratio drives rotisserie 64 at approximately four (4) revolutions per minute. This rotational speed optimizes cooking in oven 22.

Compartment 98 includes other conventional electrical components known to the art, for example, thermostats, on/off switches and so forth. The components can be attached to an external electrical source by a power cord C attached to a pigtail 115. Alternatively, a generator can be mounted on trailer 24 to operate the oven. In another aspect, the generator can be propane fueled and propane tanks 32 can be used to operate the generator to generate electricity to operate the over. External controls 116 are shown in FIG. 1. Controls 116 are appropriately wired to components within compartment 98 and mounted on removable cover panel 100. It will be appreciated that cover panel 100 includes a flange 119 on the forward and top edges that engages or mates with a flange 120 around the forward and top edge of compartment 98 to form a tight seal. This feature is important to keeping moisture out of compartment 98 when oven 22 is being transported in inclement weather. Controls include such features as an on/off switch, temperature control and rotisserie advance button. FIG. 15 illustrates a foot operated rotisserie advance 120. Rotisserie advance 120 is pneumatic and attaches by an air hose 122 to a port on controls 116. Rotisserie advance 120 can be positioned at the rear of oven 22. A user can advance rotisserie 64 by depressing the advance 120 to facilitate loading and unloading the rotisserie. It will be noted that the rotisserie advance can be mounted directly on the back of the oven within reach of the user and the air hose or other appropriate tubing concealed within the housing. There also can be a kill switch or shut down switch on the back of the housing such that it can be actuated when one of the doors is opened to stop the rotisserie.

Cooking heat is provided by firebox 47. As set out above, firebox 47 protrudes slightly out of wall 38 and includes door 48. The face 124 of firebox 47 defines an opening 125 into the firebox with a fireproof seal 126 around the opening. The firebox and opening 125 have a substantially elongated hexagonal configuration. Door 48 has a complementary elongated hexagonal extension 128 on the inside surface that fits snugly into opening 125 when the door is closed. Door 48 includes a handle 130 that rotates into catch 132 on the front of the firebox to hold door 48 tightly against seal 126. Firebox 47 includes a plurality of openings 133 in a top wall that open into the cooking chamber to provide heat and smoke.

There is a propane gas burner 134 positioned on the back wall of the firebox. Burner 134 is operatively connected to the propane tanks 32 on the trailer. Burner 134 also is operatively attached to a thermostat 136 located in the cooking compartment (FIG. 9). There is a fuel receptacle 140 in the bottom of the firebox. The fuel receptacle has a cross section that is complementary in shape to the bottom of the firebox, that is, an inverted, frusto-conical cross-section. In use, fuel, such as wood or charcoal, is place in the fuel receptacle. The fuel is ignited by burner 134. The proper cooking temperature is set by controls 116. When that temperature is reached in the cooking chamber and sensed by thermostat 136, a feedback loop shuts off the gas burner. If the temperature drops, the thermostat activates the gas burner. The combination of extension 128, seal 126 and the latch and catch form an airtight seal when the door is closed and latched that allows control of the heat in the cooking chamber.

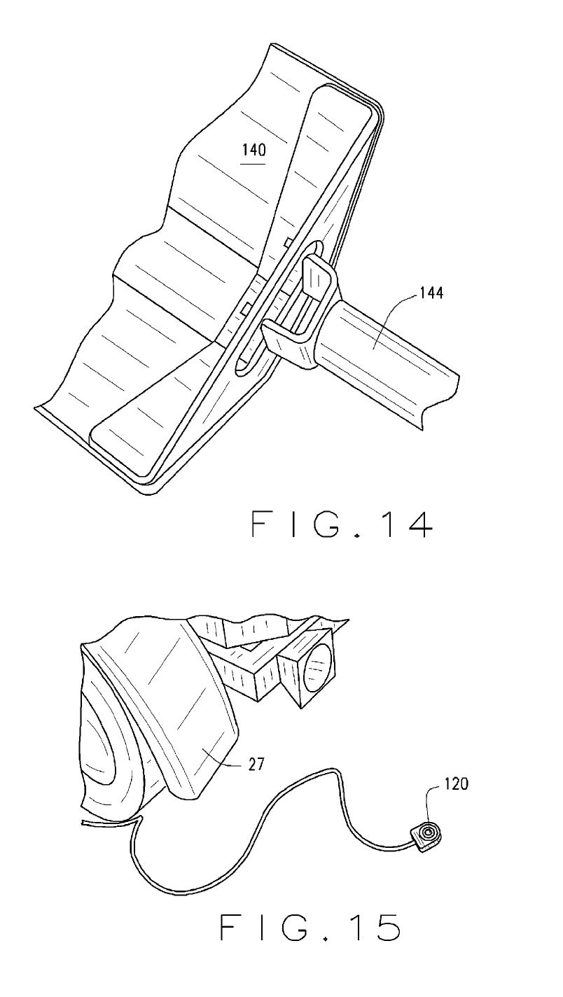

The first end or the end of the fuel receptacle closest to the door has a slot 142 that can function as a handle if the receptacle is not hot. The opposite end of the fuel receptacle is an open end 143. As seen in FIG. 14, a handle 144 can be hooked onto fuel receptacle 140 at slot 142 so that it can be removed and ashes emptied. The open end allows the ashes to be dumped. The hook and slot arranged keeps receptacle 140 attached to handle 144 even when dumping ashes.

As set out above, there are numerous accessories that can be used with the oven of the present invention. Because the pattern of bolts 49 is uniform around oven 22, accessories, such as versatile removable work surfacees can have a uniform mounting hole pattern which allows for attachment at multiple places on the oven walls

As seen in FIG. 1, a sleeve 144 can be bolted on the side of oven 22 for the removable attachment of an umbrella U. Furthermore, sleeve 144 could be a swing arm bracket that would allow the user to move umbrella U to different areas around the oven.

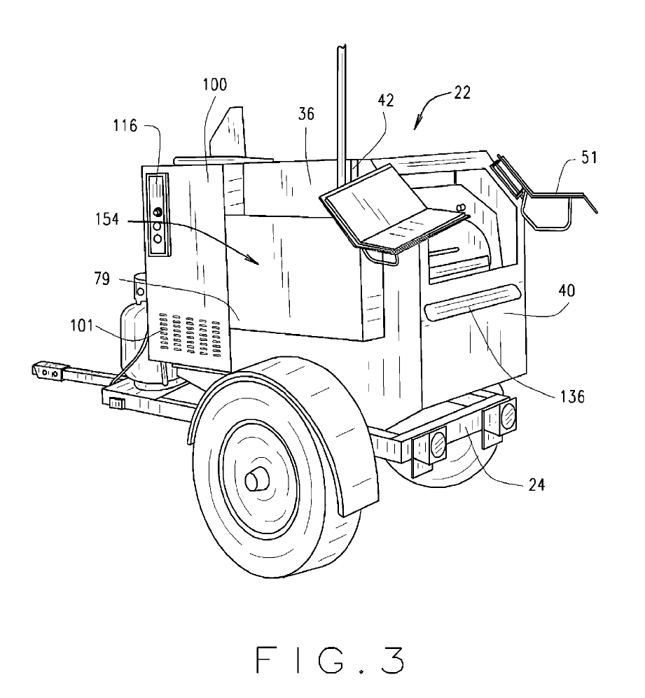

Referring to FIG. 3, a removable work surface, such as a shelf 146 can be bolted to back wall 40 under opening 56. In lieu of a shelf, a cutting board or other work surface can be bolted on the oven. Moreover, the shelf can extend along side wall 38. In another aspect, shelf 148, for example on the side of the oven, the work surface could have an opening with a removable pan under the opening for waste. On the other hand, the entire work surface could be removed and replaced by a bolt on pan that functions as a waste receptacle or sink.

In another aspect, referring to FIG. 2, the work surface can comprise a grinder or shredder attached to power takeoff 80. A pan or other work surface with a pan or sink can be bolted to wall 38 under the power takeoff to catch and contain shredded food, for example, pork or salad fixings.

In another aspect of the invention, a large, deep pan, for example a steam table pan, could be bolted to oven 22, for example, at wall 38. The pan can be filled with charcoal and a grate placed over the pan to provide an open air barbeque grill for brazing or cooking on barbeque sauce. Moreover, the pan can be equipped with a gas burner to provide a gas grill on the side of oven 22. Hence the removable work surfaces that can be attached to the oven are versatile and generally limitless in application.

In another aspect of the invention substantially rectangular shroud 150 is mounted on top wall 42. The shroud comprises a top wall, a rear end wall and two side walls. The top wall can be vented. It does not have a front wall or bottom wall. Top wall 42 of oven 22 functions as the bottom wall. The shroud has a frame around the open front that could accommodate two pans in a stacked, but separated, arrangement. A pan, for example, an 18 inch by 26 inch steam table pan containing water, is slipped into the shroud to sit on the top of the oven. A second pan containing cooked food is slipped into the shroud above the pan of water. Heat from the oven top heats the water in the lower pan and consequently, keeps the food in the upper pan warm and moist. The shroud can include a thermostat.

In another aspect, oven 22 can bear customized indicia, as shown by number 154. One particularly appropriate way of forming the indicia is to cut out indicia in panel 79 by use of a laser or the like. A contrasting color panel can be affixed to the back side of the panel to create highly visible indicia 154.

It will be appreciated from the foregoing that various changes and modifications may be made in the mobile oven of the present invention without departing from the scope of the invention. Therefore, the foregoing description and accompany figures should be viewed as illustrative only and should not be construed in a limiting sense.

1. A mobile food preparation apparatus for the preparation of food products, comprising:
an oven having first side wall, a second side wall, a front wall, a rear wall, a top wall and a bottom wall, said recited walls defining an internal food preparation chamber having a front and a rear;
a main heat source adjacent the front of the food preparation chamber;
a circulation fan in the food preparation chamber;
a rotisserie rotatably mounted in the food preparation chamber;
a baffle within the food preparation chamber between the main heat source and the rotisserie; and
a trailer supporting the oven.

2. The mobile food preparation apparatus further comprising an operational apparatus compartment adjacent the front of the oven,
a cooling fan within the operational apparatus compartment, and
a fan motor within the operation apparatus compartment, said circulation fan and said cooling fan both operatively associated with the fan motor.

3. The mobile food preparation apparatus of claim 1 wherein the oven further comprises a food warmer on an external surface of the top wall of the oven.

4. The mobile food preparation apparatus of claim 1 wherein the rotisserie further comprises a plurality of laterally extending, substantially V-shaped spits.

5. The mobile food preparation apparatus of claim 1 wherein the rotisserie further comprises a plurality of wire racks pivotally attached to the rotisserie whereby the racks maintain a substantially uniform orientation as the rotisserie rotates within the food preparation chamber.

6. The mobile food preparation apparatus of claim 1 wherein the oven further comprises a power takeoff for the attachment of a food grinder or chopper.

7. The mobile food preparation apparatus of claim 1 wherein the oven further comprises at least one removable work surface on an external side of the oven.

8. The mobile food preparation apparatus of claim 1 wherein the back wall of the oven is angled.

9. The mobile food preparation apparatus of claim 8 wherein back wall defines an opening into the food preparation chamber and the oven further comprises a pair of gull wing doors at the opening.

10. The mobile food preparation apparatus of claim 1 wherein the oven further comprises a foot operated rotisserie advance switch.

11. The mobile food preparation apparatus of claim 1 wherein the main heat source is a firebox.

12. The mobile food preparation apparatus of claim 11 wherein the firebox comprises a removable fuel receptacle therein, said fuel receptacle having one open end and means at the other end for attachment of a handle whereby contents of the firebox can be removed from the firebox.

13. The mobile food preparation apparatus of claim 1 wherein the circulation fan has a downwardly angled fan shaft.

14. An oven for removable mounting on a trailer, comprising:
an first side wall, a second side wall, a front wall, a rear wall, a top wall and a bottom, said recited walls defining an internal food preparation chamber having a front and a rear, the rear wall defining an opening into the food preparation chamber;
a pair of opposed doors attached to the rear wall at the opening into the food preparation chamber;
a firebox adjacent the front of the preparation chamber;
a circulation fan in the preparation chamber, said circulation having a downwardly angled fan shaft;
a rotisserie rotatably mounted in the food preparation chamber; and
a baffle between the firebox and the rotisserie defining air flow pathways around the baffle.

15. The oven of claim 14 wherein the firebox comprises a removable fuel receptacle therein, said fuel receptacle having one open end and means at the other end for attachment of a handle whereby contents of the firebox can be removed from the firebox.

16. The oven of claim 14 further comprising at least one external removable work surface.

17. The oven of claim 14 wherein the rotisserie further comprises a plurality of laterally extending, substantially V-shaped spits.

18. The oven of claim 14 wherein the rotisserie further comprises a plurality of wire racks pivotally attached to the rotisserie whereby the racks maintain a substantially uniform orientation as the rotisserie rotates within the food preparation chamber.
